(19) United States
(12) Patent Application Publication
(10) Pub. No.: US 2026/0350014 A1
(43) Pub. Date: Nov. 5, 2026

(54) DYNAMIC CORRELATION OPERATIONS FOR IDENTIFIER MAPPING IN A COMMUNICATIONS SYSTEM

(71) Applicant: Microsoft Technology Licensing, LLC, Redmond, WA (US)

(72) Inventors: Swadhin Ajay THAKKAR, Kent, WA (US); Yi GUO, Suzhou (CN); Yingji JU, Renton, WA (US); Steve Chun-Hao HU, Bellevue, WA (US); Xu LIU, Sammamish, WA (US); Xue WANG, Mercer Island, WA (US)

(21) Appl. No.: 19/194,677

(22) Filed: Apr. 30, 2025

(51) Int. Cl. G06F 16/2455; G06F 16/22; H04L 12/18

(52) U.S. Cl. CPC G06F 16/2456; G06F 16/2246; H04L 12/1831

(57) ABSTRACT

Techniques and systems are disclosed to track identifiers used among multiple segments of a communication session, to enable a coherent data record such as a call record of related communication session segments. An example method includes: receiving telemetry events that include change events produced from changes to respective communication session segments; extracting identifiers of related segments from the change events, including primary and secondary identifiers of first and second communication session segments that are related; merging the multiple identifiers from the change events into a data structure, when a respective primary identifier or a respective secondary identifier is already tracked in the data structure; and outputting a data record for the communication session, based on data relationships merged into the data structure. This data record uses the multiple identifiers to create an association among the telemetry events produced by the related communication session segments.

### BACKGROUND

Current communications systems support a wide variety of interactive communication types and actions for users, including video and voice calls, meetings, and conference calls, involving very few users in some settings, and involving hundreds or even thousands of users in other settings. In many settings, telemetry data is generated that identifies user activity and system events associated with a user, such as which users were present on a call, which user talked with which agents, which users participated in a chat and a follow-up voice call, and many other scenarios. This information can be useful not only for system auditing and logging, but also to track end-to-end aspects of a user experience and actions.

The dynamic nature of communication sessions, including call transfers, call merges, meeting changes, and multiple modes of interaction may prevent a complete record from being created for a user's communication activity. For instance, when call merges, splits, and transfers occur among different users, call records can become duplicated or unconnected with each other. Thus, many current approaches for tracking communication session events will result in fragmented or incomplete records that do not capture the full record of user activity.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a scenario of communications system operations, according to various examples of the present disclosure.

FIG. 2 depicts a flowchart of operations performed by a telemetry data correlation mechanism for managing tree data structures, according to various examples of the present disclosure.

FIG. 3 depicts a scenario of storing a tree data structure in a database table, according to various examples of the present disclosure.

FIGS. 4A, 4B, and 4C depict scenarios of merging data from tree data structures, according to various examples of the present disclosure.

FIG. 5 depicts a flowchart of a method performed for tracking identifiers of a communication session hosted by a communications system, according to various examples of the present disclosure.

FIG. 6 illustrates a schematic of operational and functional components used among systems and devices to track identifiers of a communication session, according to various examples of the present disclosure.

FIG. 7 is a block diagram illustrating an example of a machine upon which one or more embodiments may be implemented.

### DETAILED DESCRIPTION

Disclosed in some examples are methods, systems, devices, and associated operations and functionality that enable the data analysis and tracking of various identifiers and other metadata from events and metadata generated in a communications system. In particular, dynamic correlation operations are discussed in the following examples to merge multiple call or communication event identifiers (IDs) from many telemetry events and communication session segments, into a single communication session “experience” data record.

In one example, a tree-based data structure (referred to herein as an “ID-Tree”) is used to track communication session telemetry event data in real time, where each node of the tree tracks a separate communication session identifier such as a unique call ID. Whenever new telemetry event data is received that indicates two or more identifiers are related—via communications system events such as a call transfer, PSTN bridging, breakout rooms, and the like—the corresponding tree data structures are dynamically merged so that all relevant identifiers (e.g., identifiers from related call segments) are linked to a single root.

This use of a tree-based data structure enables data processing of communications system telemetry events in a variety of distributed devices and settings. In an example, edges (e.g., connections) of the tree data structure are tracked in a distributed data store or database using a root-leaf model that is easy to query and locate either of two identifiers that are associated with each other. This approach scales well for large volumes and complex scenarios of calls and other communications system events, including those generated from Public Switched Telephone Network (PSTN) calls and events, Voice-over-IP (VoIP) and Session Initiation Protocol (SIP) interoperability, large conference calls and meetings, etc.

The following techniques also include the use of prioritized data merge logic, to enable separate tree data structures to be suitably merged if the separate tree data structures are tracking identifiers of telemetry events from separate segments of the same communication session. When merging two trees, weights are assigned (e.g., weights corresponding to an “already generated call record,” “leaf count,” “primary ID”, as discussed below) to determine a consistent root of the tree data structure. This prevents confusing changes to established call IDs data structures and yields a stable identifier correlation hierarchy. By inserting new “merged” edges and removing old ones in the same transaction, these techniques ensure immediate data consistency and avoid partial data merges that can corrupt call records.

The following techniques can be used to produce a unified, end-to-end coherent data record, even when the underlying call or communication session spans multiple links and uses many related identifiers for different segments. This coherent data record is referred to in many of the following examples as a “Call Record” but can encompass other scenarios beyond the use of a voice or video call. The techniques discussed herein can be deployed in a distributed data processing environment (including but not limited to Cosmos DB, Spark/Scala, and the like) that can seamlessly correlate partial sessions with minimal latency, ultimately generating and tracking more complete communication session metadata while reducing duplication.

One of the technical problems addressed by the present techniques includes data management and data integrity, particularly in the context of a communication system and for related applications that consume communication system data. As discussed above, existing approaches for tracking communication system telemetry data often may provide fragmented, duplicated, or incomplete information, and require additional data processing to try to identify which user activities and events are related. Existing approaches that rely on a single global ID or batch post-processing often are unable to link data in real-time and may require a variety of workarounds or human intervention to create a view of a complex communication session.

One of the technical solutions introduced with the present architecture is the improved accuracy and efficiency of data processing operations, enabled by a coherent data record that can track multiple types of identifiers and relationships between communications system events. Further, the following techniques can be used with dynamic, real-time merging operations to maintain and update a data record (the ID-Tree) as soon as new telemetry data arrives, preventing fragmented or partial records. These approaches also provide improved transactional integrity and data accuracy, improvements to the resulting data storage and queries, and accompanying efficiencies in processing power, storage and memory resources, bandwidth, etc. These and other technical benefits will be apparent from the following examples and illustrations.

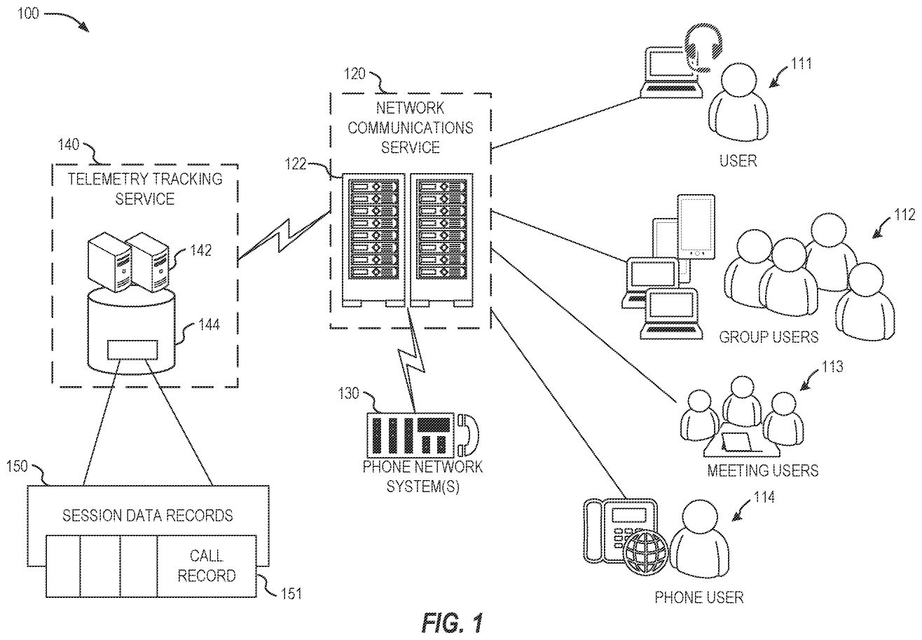

FIG. 1 illustrates an example scenario 100 of communications system operations. Specifically, the scenario 100 shows how a network communications service 120 is used to host and facilitate various communication sessions among different combinations of users. For instance, the network communications service 120 is shown as providing voice and video call services to a user 111, compute content sharing services to a group of users 112, meeting conference calls to meeting users 113, and telephony services to a phone user 114.

The network communications service 120 may use a variety of communication modes including but not limited to voice, video, text, or other forms of interaction between two or more entities. Thus, as discussed herein, the usage of the term “call” is not limited to traditional telephony but extends to modern communication platforms such as Voice-over-IP (VoIP), Public Switched Telephone Network (PSTN) calls, text and content sharing collaborations and meetings, presentations, and hybrid sessions that integrate one or multiple communication modes. Thus, the techniques discussed herein are not limited to tracking information for phone or voice calls but may extend to a variety of types and forms of network communications and interactions between and among different types of users, devices, and agents (including artificial intelligence (AI)-based agents).

The network communications service 120 includes networking and computing hardware such as servers 122, routers, switches, and software components that perform compute and networking operations such as switching, data routing, session handling, and protocol usage. The network communications service 120 may be hosted in a data center or a distributed computing location. The network communications service 120 is communicatively coupled to other network hardware, such as one or more phone network systems 130 and network equipment (not shown), and various public and private data networks (not shown).

The scenario 100 also depicts the use of a telemetry tracking service 140. This service may be operated by one or more computing systems 142 and data stores 144 that collect and log telemetry events. The telemetry tracking service 140 may specifically maintain communication session data records 150, including individual call records such as a Call Record 151. A Call Record can provide a comprehensive data representation of a communication session, including relevant telemetry events, identifiers, and metadata associated with the session. A Call Record is typically generated by aggregating and correlating telemetry data from various sources, such as clients, devices, and services involved in the session.

As an operational example, consider a scenario where a Call Record 151 is created based on multiple telemetry events collected from various segments, involving different combinations of clients, services, and activities in calls, meetings, or other online collaborations. The Call Record 151 can be created to represent the true state of an end-to-end communication session for one or more users, such as for use with reporting, monitoring, reliability, and analytical tasks, as well as compliance and legal requirements.

As discussed above, it can be a complicated task to correlate multiple telemetry events to create a complete Call Record with the necessary information to support various scenarios and requirements. In a simple scenario, when a single call or meeting starts, a unique identifier (Call-ID) may be created and used to identify the call or meeting. In this simple scenario, all the telemetry data sent from different clients and services are likely to share the same Call-ID. Thus, to generate a Call Record, all telemetry events that involve the same Call-ID can be easily aggregated/merged to generate the Call Record.

In more complicated scenarios such as a call transfer, breakout room, or calls involving interoperability—where multiple calls and meetings are part of a larger communication session—the events belonging to the same scenario may use multiple different IDs (e.g., because different calls are ongoing at the same time). Thus, there is a technical need to correlate multiple IDs in a system to create a complete and accurate Call Record. An individual call event in the chain may only have information about the preceding and following events, but may be disconnected from other call segments.

For example, consider the following scenario where the following call events are sequentially received from a communications system, such as network communications service 120:

TABLE 1

| Time Stamp | Event Id | Correlation ID 1 | Correlation ID 2 |
|---|---|---|---|
| T = 0 | 1 | ID-1 | ID-2 |
| T = 1 | 2 | ID-11 | ID-12 |
| T = 2 | 3 | ID-1 | ID-3 |
| T = 3 | 4 | ID-11 | ID-13 |
| T = 4 | 5 | ID-2 | ID-12 |

In this scenario, Event #1 is received first, which has ID-1 and ID-2, and Event #2 is received second, which has ID-11 and ID-12. At this point, Event #1 and Event #2 belong to different experiences. Next, the system receives Event #3 which has ID-1 and ID-3, Event #4 which has ID-11 and ID-13. Because Event #1 and Event #3 use a common ID-1, these events are part of the same experience. Likewise, because Event #2 and Event #4 have the common ID-11, these events are also part of the same experience. Then, when Event #5 is received, which includes ID-2 and ID-12, this event can be used to correlate Event #1 and Event #2 together. As a result, all five events should be correlated together, to track one end-to-end experience of a communication session in a Call Record.

Thus, to generate a complete Call Record to represent this end-to-end view of the communication session scenario, multiple IDs need to be correlated to the same experience. This is particularly difficult in scenarios such as shown in Table 1 where separate data pieces are unconnected, and the overall communication session cannot be understood until events from the individual segments are correlated and linked together. To accomplish this, the following introduces a correlation mechanism that associates related IDs in a tree data structure, as aggregated for an overall communication session.

When the system receives a telemetry event, such as change events that are produced from some changes to a communication session segment, the identifiers in these change events, hereinafter “correlation IDs”, are extracted. If there is only one correlation ID, no action is needed. If there is more than one correlation ID, then an ID-tree is created to host the correlation IDs (e.g., when there is no ID-tree associated with any of the correlation IDs) or the correlation IDs are merged into an existing ID-tree (e.g., when an ID-tree is already associated with one of the correlation IDs). This correlation mechanism is arranged to operate in a distributed system, to serve large-scale operations with low latency and to associate all the related correlation IDs in an ongoing basis into a same tree data structure. This provides a scalable and adaptable approach that can be used to track related events in a variety of settings.

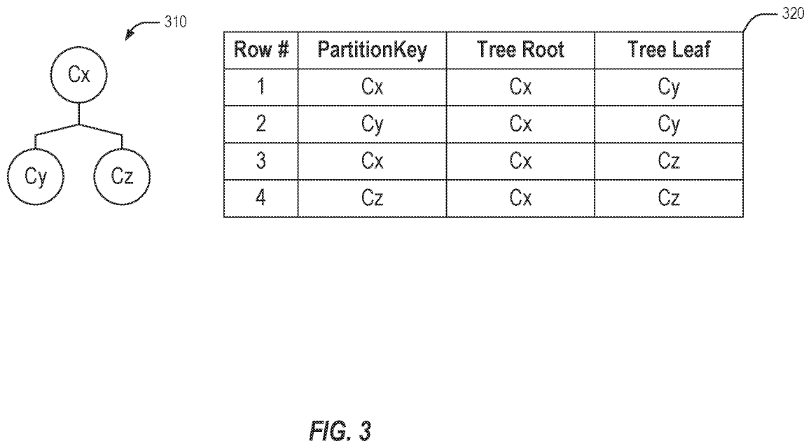

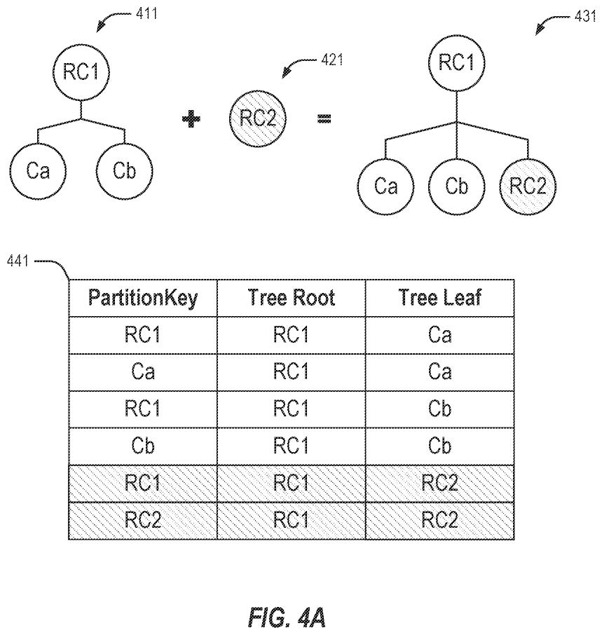

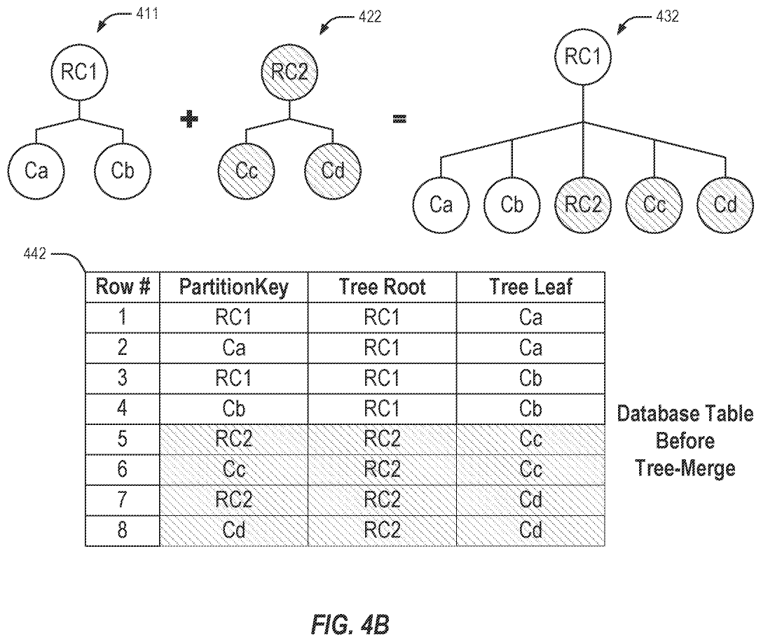

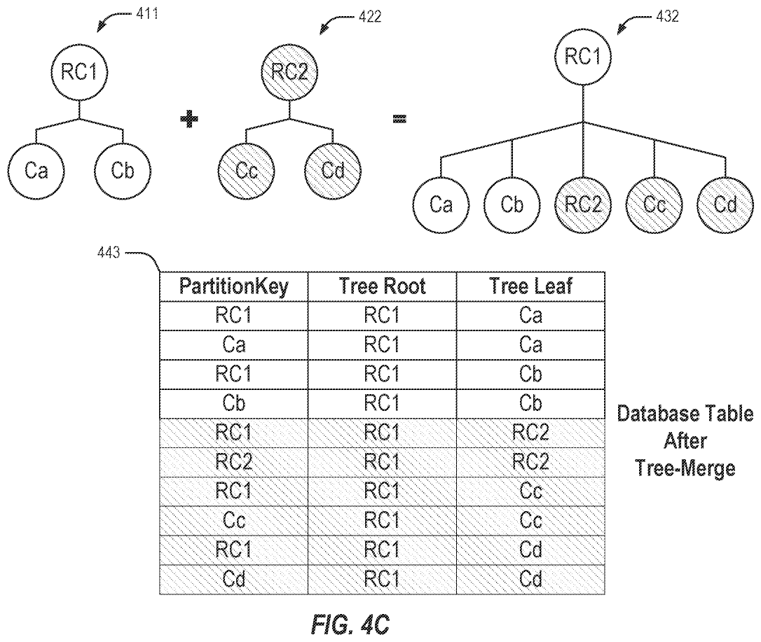

Thus, an ID-tree is a tree data structure whose nodes are all IDs. The root node of the ID-tree is an artificial ID or any ID chosen in a determined way. Physically, an ID tree can be implemented as simple table, Key/Value store, Graph, etc. Each row has 2 IDs, which means ID1 belongs to ID2. An ID-tree can be defined to have a maximum depth, and no overlap. The tracked properties of ID-Tree Node can include the depth of a current ID-Tree. Examples of such ID-trees are depicted among FIGS. 3 to 4D and discussed in more detail below.

To accomplish the correlation of IDs, the following introduces a dynamic ID-tree that merges all related correlation IDs into the same tree. This tree provides a scalable approach that can be adapted over time. This approach is also dynamic because it is unclear how many IDs will be associated, which sessions will be merged with another session at a later time, or how multiple sessions could overlap with each other. This approach also reduces the probability of generating multiple separate call records. For example, in the above TABLE 1, the use of tree merging can prevent the need to create two call records before event #5 is received—which can result in an optimized data flow.

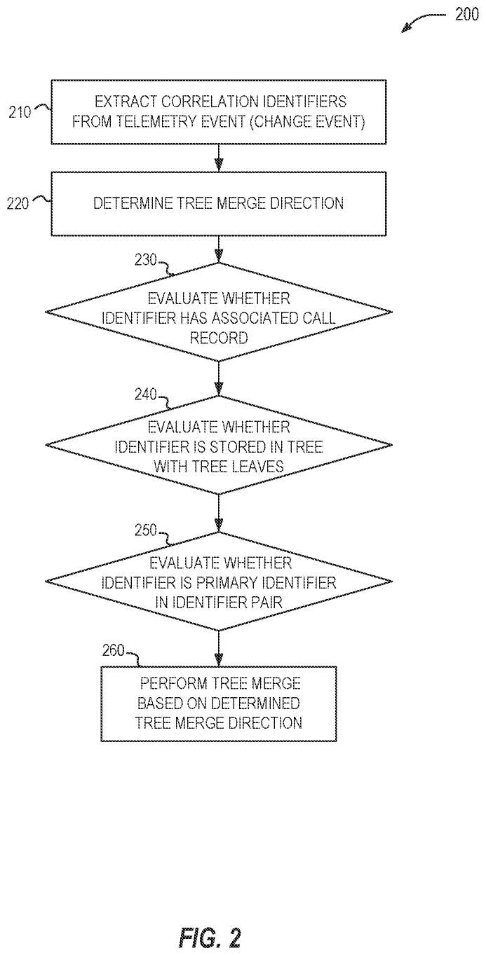

FIG. 2 depicts a flowchart 200 of operations performed by a telemetry data correlation mechanism for managing tree data structures of identifiers. In particular, this flowchart 200 shows the primary operations to correlate identifiers from telemetry events, such as change events that are produced from changes (e.g., merges, transfers, branches, etc.) to the respective communication session segments and provide related call identifiers.

At operation 210, correlation IDs are extracted from the telemetry event(s). This produces at least one set of primary and secondary identifiers that can be tracked in a tree data structure. Each telemetry event includes one or more Correlation IDs and EventData (e.g., the content of the telemetry event).

At operation 220, one or more evaluations are performed to identify how to merge the tree data structures associated with the primary and secondary identifiers, by determining a tree-merge direction. These may include: evaluating whether the identifier has an associated call record (evaluation 230); evaluating whether the identifier is stored in a tree with tree leaves (evaluation 240); and evaluating whether the identifier is the primary identifier in an identifier pair (evaluation 250). Each of these evaluations may produce a corresponding weight, as discussed below.

At operation 260, the tree-merge is performed based on the determined tree-merge direction. Results of these tree-merges are depicted in FIGS. 4A to 4C, and discussed in more detail below.

In some examples, all telemetry events contain and can be indexed by a column named Call_ID. Only part of the telemetry events may contain information about some other call id(s), which indicates those call identifiers should be correlated together. Thus, operation 210 can output a list of ID-mapping pairs. Each pair can be provided in the form of <PrimaryCorrelationld, SecondaryCorrelationId>. PrimaryCorrelationId is the call identifier of the telemetry event, and SecondaryCorrelationId is another call identifier extracted from this event. Their names suggest different priorities. As will be understood, multiple ID-mapping pairs may be extracted from a single telemetry event.

The determination of a tree-merge direction of operation 220 may consider multiple scenarios involving the call record and maintained data structures. Assume there is an ID-mapping pair <C1, C2> indicated in some telemetry event. Based on these identifiers, an evaluation is performed to determine if a merge of data structures is required and, if so, which direction to merge (e.g., merge a tree data structure representing C2 data into C1, or merge a tree data structure representing C1 into a tree data structure representing C2).

Accordingly, this evaluation determines what type of tree data structure merge operation is needed, based on the data stored in each tree. Both C1 and C2 can be transformed into their current tree roots, and the tree root can represent the whole ID-Tree, so the roots instead of the leaves can be compared to determine the merge direction.

FIG. 3 depicts an example scenario of storing an example ID-Tree 310 in a database table 320. Here, a NoSQL database (e.g., Azure Cosmos DB for NoSQL) can be used to implement the tree data structure. The use of a schema-less NoSQL database, in some settings, may have some performance advantage over relational databases like MySQL for scalability and over Graph Databases for simplicity. However, other types of databases may be used.

FIG. 3 specifically shows how the ID-Tree 310 includes an example arrangement with Cx as a tree root, Cy and Cz as the tree leaves. The database table 320 shows how this tree arrangement can be persisted in a NoSQL database (e.g., Azure Cosmos DB or the like). For each tree edge, two rows are persisted with the same combination of Tree Root and Tree Leaf but different PartitionKey. This arrangement provides better query performance in return. For example, a query can obtain the graph edge with root Cx and leaf Cy when querying with PartitionKey equals to either Cx or Cy. In other words, without row #2, it will be very slow and very expensive to know which edge Cy is in. This database table arrangement is used to illustrate specific merge examples in FIGS. 4A to 4C.

For any call identifier Cx, there are three scenarios, including: Scenario 1: Cx is encountered for the first time and within no ID-Tree for now; Scenario 2: Cx is its own tree root; Scenario 3: Cx has a tree root Cy. Those three scenarios can be further divided into two types: 1) Root of Cx is Cx. 2) Root of Cx is Cy.

After the transformation, the ID-mapping pair becomes <RC1, RC2>. Then, the necessity and direction of tree-merge can be determined. If RC1 RC2, there is no need for tree-merge because they are already correlated together, or in other words, they are already part of the same ID-Tree. Otherwise, the properties of RC1 and RC2 can be compared. In a scenario where RC1 !=RC2, a tree-merge is necessary, and the merge direction has been decided (based on the results of operation 260), which is to merge tree RC2 into tree RC1. In an example, the following properties are used to assess the tree structures, to determine which direction to merge:

TABLE 2

| Property | Weight | Evaluation Criterion |
|---|---|---|
| IsPrimary | 10 | True if the root is PrimaryCorrelationId |
| | | in the idmapping pair. |
| WithLeaves | 100 | True if the root has one or more tree leaves. |
| WithCallRecord | 1000 | True if the root has already triggered |
| | | generation of call record. |

The WithCallRecord property is assigned the highest weight to enable the call ID of all call records for the same call to be consistent. If, for example, root RC2 has already triggered the generation of some call records, tree RC1 is merged to tree RC2. Otherwise, the call ID of higher version call records would change from RC2 to RC1, which may corrupt data.

The WithLeaves property is used when both tree roots have not triggered any call record, to provide a preference for the tree with tree leaves. For instance, if root RC2 has tree leaves but root RC1 does not have tree leaves, then this property causes the merge of tree RC1 into tree RC2. In such a scenario, it is a simpler operation to add a new edge to an ID-Tree than to merge one tree into another.

The IsPrimary property is considered as a tiebreaker only when the other two properties are the same between two roots. Since RC1 is labeled as primary and RC2 is labeled as secondary, then this property will cause a merge of tree RC2 into tree RC1.

FIG. 4A depicts a use case where the added tree (RC2 421) has no tree leaves, with data for a merged tree 431 represented in database table 441. Here, the merge may be accomplished by adding a new edge into tree RC1 411, to change tree RC2 421 into a new tree leaf of tree RC1 411. This is shown with the addition of two database rows to show that the RC2 is a leaf of RC1 (with the rows respectively depicting the use of RC1 and RC2 as the PartitionKey).

FIGS. 4B and 4C depict a use case where the added tree (RC2 422) has one or more tree leaves. As shown, existing tree RC1 411 has leaves Ca and Cb, while the added tree RC2 422 has leaves Cc and Cd. These trees are merged (merging RC2 into RC1) to produce a merged tree 432.

FIG. 4B first illustrates how the two trees, RC1 411 and RC2 422, can be represented in a database table 442. Here, rows 1 to 4 of the database table 442 represent initial data from RC1 411 and rows 5 to 8 of the database table 442 represent initial data from RC2 422.

There are three operations used to accomplish the tree-merge in the database table 442. First, the database table 442 is queried to identify rows where PartitionKey equals RC2, to identify all nodes within tree RC2 432. The query returns row number 5 and row number 5, to indicate that the tree RC2 432 contains three nodes [RC2, Cc, Cd]. Next, six rows are inserted into the database table to create three new edges between RC1 and the various nodes, to represent the relationship shown in the merged tree 432: RC1->RC2, RC1->Cc, and RC1->Cd. Finally, a delete operation is performed to delete rows where PartitionKey is equal to RC2, Cc, and Cd respectively. This will delete rows No. 5 to No. 8 in the database table 442. These insertion and deletion operations should be transactional to prevent an inconsistent state of the database.

FIG. 4C shows a resulting database table 443 after the tree merge, merging tree RC2 422 into RC1 411, with the database table 443 reflecting the full state of the merged tree 432.

Accordingly, the resulting merged data records produced from these techniques can be used to support a number of use cases, including scenarios for unified analytics and reporting. The merged data records can provide a single view of multi-leg calls or meetings among different users and automated agents, which can be important for usage insights, troubleshooting, and compliance. This may provide a variety of resource savings, including avoiding generating redundant partial call records, thus reducing storage and computation overhead.

The resulting merged data records can support an enhanced customer Experience in a variety of downstream tools. For example, tools and dashboards see one cohesive meeting/call record, eliminating confusion from fragmented or missing data. Further, even as different communication services evolve to include more sophisticated transfers, PSTN interoperability, and multi-tenant scenarios, the techniques for dynamic correlation of data events ensure that complex information can be tracked without needing new specialized logic. These techniques may further support a variety of Backend Telephony/Data Engineering workflows requiring scalable correlation of call-related events in near real-time.

While the techniques discussed herein for merging data records were described with reference to cloud-hosted communications systems, it will be understood that these techniques can apply to any number of communications or collaboration platforms that involve complex multi-segment or multi-party scenarios, or in scenarios that unify call or interaction logs. These techniques may also be used in hardware architectures where multiple processors need to communicate with each other and maintain state.

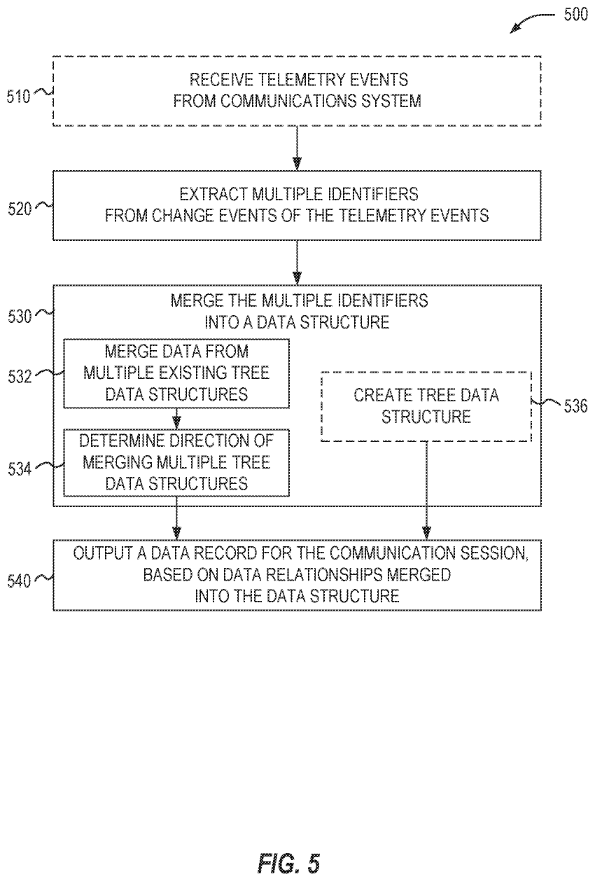

FIG. 5 depicts a flowchart 500 of a method for tracking identifiers of a communication session hosted by a communications system. The flowchart 500 of FIG. 5 commences with the receipt of telemetry events and data from a communications system (operation 510), as the communications system facilitates respective communication session segments between entities. These telemetry events include change events that are produced from changes to the respective communication session segments. Other types of events may be provided in the telemetry events. In a further example, the respective event provides multiple pairs of primary identifiers and secondary identifiers, and operation 510 includes extracting the multiple pairs of primary identifiers and secondary identifiers from the respective event.

The flowchart 500 continues with operations to extract identifiers of related segments from the change events (operation 520). A respective event of the change events provides multiple identifiers including (i) a primary identifier of a first communication session segment and (ii) a secondary identifier of a second communication session segment related to the first communication session segment. For instance, the first communication session segment can involve a call occurring via the communications system, as the primary identifier provides an identifier of the call, and the secondary identifier provides another identifier of a related call or action occurring in the communications system to be associated with the call.

The flowchart 500 continues with operations to merge the multiple identifiers into a data structure (operation 530), such as a tree data structure used for correlating identifiers as discussed above. In a first example, the identifiers are merged into an existing data structure (operation 532) when a respective primary identifier or a respective secondary identifier is already tracked in the data structure. In a second example, the identifiers may be created into a new tree data structure (operation 536) if neither identifier is already tracked in the data structure.

A tree data structure may be maintained in a database using a multi-row storage pattern to track the identifiers, as discussed above. A respective data entry stored in a row of such a database can be used to track a key, a tree root, and a tree leaf of the tree data structure. In this scenario, merging of the multiple identifiers can include merging data from a second tree data structure into the first tree data structure, by adding data from the second tree data structure as leaves of the first tree data structure.

As noted above, the merging of the tree data structures can include determining a determining a direction for merging a first tree data structure and a second tree data structure (operation 534). The direction for merging into a merged tree data structure can be based on weights that correspond to: whether a root of the merged tree data structure corresponds to the primary identifier; whether the root of the merged tree data structure has one or more tree leaves; whether the root of the merged tree data structure is associated with an existing data record; or other considerations discussed above.

The merging of the multiple identifiers from the change events into the data structure can occur in real-time during use of the respective communication session segments (e.g., as calls or meetings are ongoing). In specific examples, the respective communication session segments involve at least one of: a user-to-user call, a multi-party call, a user-to-agent interaction, a meeting, a breakout room, a webinar, or a call transfer. As will be understood, such segments may include various forms of voice, video, text, and other human-to-human, human-to-agent, or agent-to-agent interactions (including with the use of bots and autonomous agents).

The flowchart 500 continues to output a data record for the communication session based on data relationships merged into the data structure (operation 540), such as to output a Call Record as discussed herein. The data record is created by using the multiple identifiers to create an association among the telemetry events produced by the related segments of the communication session. This data record can be used to associate information from a plurality of telemetry events associated with a user of the communications system during a call or meeting hosted by the communications system.

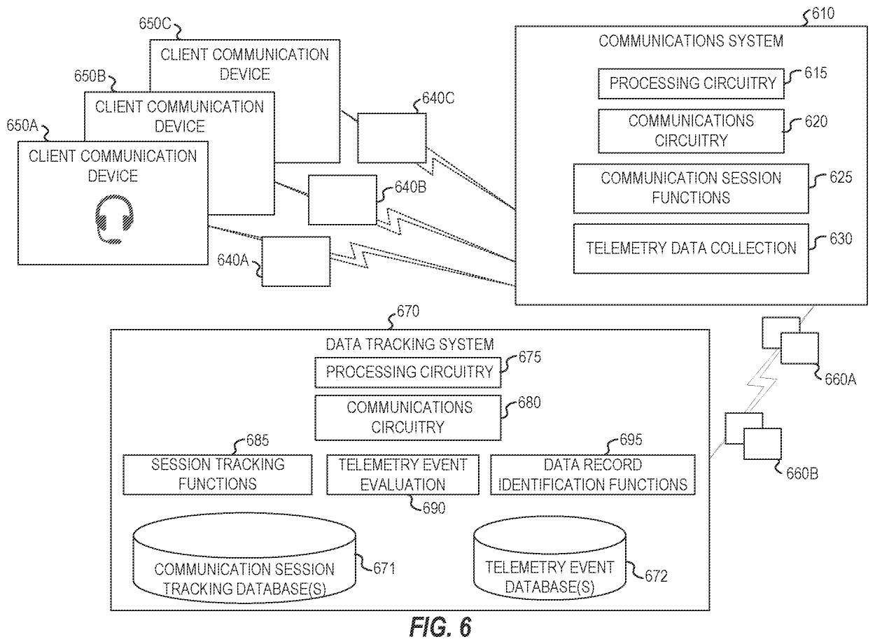

FIG. 6 illustrates a schematic of operational and functional components used among systems and devices to track identifiers of a communication session, including to implement the techniques discussed above. The systems and devices include a communications system 610, client communication devices 650 (shown with devices 650A, 650B, 650C), a data tracking system 670, and various sub-components, many of which are not depicted for simplicity. The communications system 610 may be an example of a server that implements the services (e.g., network communications service 120) via various compute and network resources (e.g., VoIP, phone network, or data service resources). The client communication devices 650 may be an example of the user devices used to engage with the communication session(s) discussed herein. Any of the communications system 610, the client communication devices 650, and the data tracking system 670 may be communicatively connected via a local or wide area network and variations of wired or wireless networks.

The communications system 610 is depicted in FIG. 6 as including processing circuitry 615, communications circuitry 620, communication session functions and telemetry data collection functions 630. The communications service functionality 625 may enable use of telecommunication and data communication services such as voice, video, data transfer, and the like, consistent with the examples here. The telemetry data collection functions 630 can be used to perform telemetry functions and collect telemetry data on various events involving the client communication devices 650, such as involving data 640 transferred between the communications system 610 and the devices 650 (shown as respective data 640A, 640B, 640C). The devices 650 may include a variety of communications interface capabilities such as VoIP software or hardware (e.g., audio processing hardware, videoconferencing software) used to perform (e.g., receive inputs, provide outputs) calls, chats, conferencing, or other aspects of human-to-human or human-to-machine communications.

The data tracking system 670 may be an example of a server that implements telemetry data processing services including to enable the data correlation and service operations discussed herein. The data tracking system 670 may utilize communications circuitry to receive various telemetry events 660A, 660B, and data included therein from the communications system 610. The data tracking system may execute session tracking functions 685, telemetry event evaluation functions 690, and data record identification functions 695, consistent with the examples provided above. This data may be maintained in data stores including one or more communication session tracking databases 671, and one or more telemetry event databases 672.

The components shown in FIG. 6 may be embodied or implemented in hardware, software, or any combination thereof. The functionality of each component is one example arrangement of functionality and one of ordinary skill with the benefit of the present disclosure will appreciate that other organizations are possible. Each of the illustrated systems 610 and 670 are depicted as including processing circuitry 615 and 675, such as a hardware processor (e.g., CPU) and memory configured to execute respective software instructions. Further, one or more of the functions of one or more the communications system 610 may be performed by distributed components within the overall system.

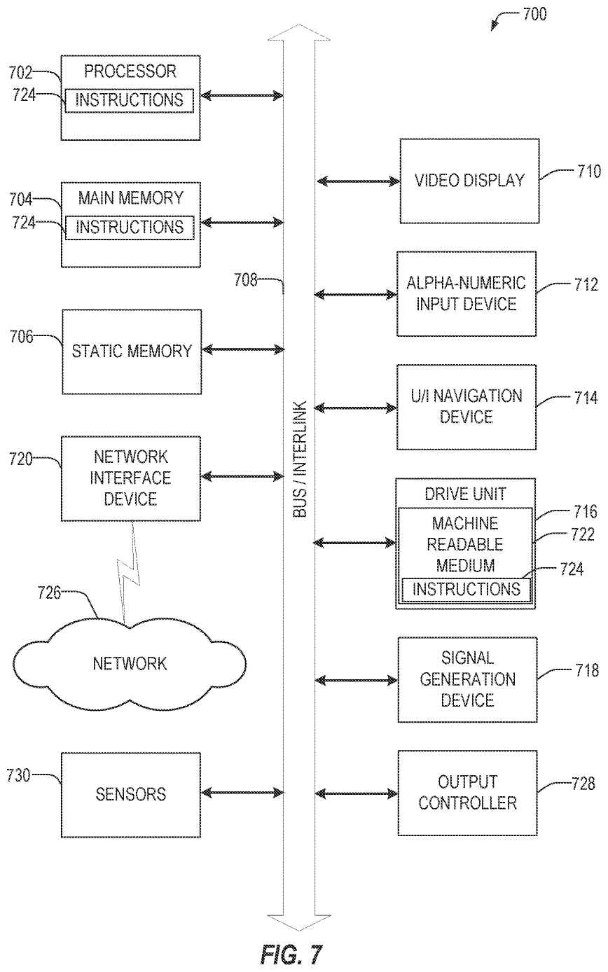

FIG. 7 illustrates a block diagram of an example machine 700 upon which any one or more of the techniques (e.g., methodologies) discussed herein may perform. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a computing device such as a personal computer (PC), a tablet PC, a personal digital assistant (PDA), a mobile telephone, a cloud-based or networked server, a virtualized server, a smart phone, a web appliance, a network router, an access point, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 700 specifically may implement the server 122, systems 130, 142, 610, and 670, or the operations illustrated among FIGS. 1-6.

Examples, as described herein, may include, or may operate on, logic or a number of components, modules, or mechanisms (hereinafter “components”). Such components are tangible entities (e.g., hardware) capable of performing specified operations and may be configured or arranged in a certain manner. In an example, circuits or circuitry may be arranged (e.g., internally or with respect to external entities such as other circuits or circuitry) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium, such as a non-transitory machine-readable storage medium. In an example, the software, when executed by the underlying hardware of the component, causes the hardware to perform the specified operations.

Accordingly, such a component encompasses a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. Examples of main memory 704 may include Synchronous Dynamic Random-Access Memory (SDRAM), such as Double Data Rate memory, such as DDR4 or DDR5. Interlink 708 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like.

The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 730, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, a machine-readable medium may include a single medium or multiple media (e.g., a centralized or distributed database, and/or associated caches and servers) configured to store the one or more instructions 724. Thus, the term machine readable medium may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions.

Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media (e.g., excluding a transitory propagating signal).

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), satellite communication networks, and wireless data networks, such as networks implementing the Institute of Electrical and Electronics Engineers (IEEE) 802.11 family of standards known as Wi-Fi®, a 5G or 4G/Long Term Evolution (LTE) family of standards, satellite communication networks, peer-to-peer (P2P) networks, among others. In an example, the network interface device 720 may include one or more physical interfaces (e.g., Ethernet, coaxial, or optical interfaces) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method for tracking identifiers used in a communication session hosted by a communications system, comprising: receiving telemetry events from the communications system, wherein the communications system facilitates respective communication session segments between entities, and wherein the telemetry events include change events that are produced from changes to the respective communication session segments; extracting identifiers of related segments from the change events, wherein a respective event of the change events provides multiple identifiers including (i) a primary identifier of a first communication session segment and (ii) a secondary identifier of a second communication session segment related to the first communication session segment; merging the multiple identifiers from the change events into a data structure, when a respective primary identifier or a respective secondary identifier is already tracked in the data structure; and outputting a data record for the communication session, based on data relationships merged into the data structure, wherein the data record uses the multiple identifiers to create an association among the telemetry events produced by the related segments of the communication session.

In Example 2, the subject matter of Example 1 optionally includes wherein a respective event provides multiple pairs of primary identifiers and secondary identifiers, and wherein the method includes extracting the multiple pairs of primary identifiers and secondary identifiers from the respective event.

In Example 3, the subject matter of any one or more of Examples 1-2 optionally include wherein the first communication session segment involves a call occurring via the communications system, wherein the primary identifier is an identifier of the call, and wherein the secondary identifier is another identifier of a related call or action occurring in the communications system to be associated with the call.

In Example 4, the subject matter of any one or more of Examples 1-3 optionally include wherein the data structure is maintained as a tree data structure in a database using a multi-row storage pattern, wherein a respective data entry stored in a row of the database indicates a key, a tree root, and a tree leaf of the tree data structure.

In Example 5, the subject matter of Example 4 optionally includes wherein the tree data structure is a first tree data structure, wherein the merging of the multiple identifiers includes merging data from a second tree data structure into the first tree data structure, by adding data from the second tree data structure as leaves of the first tree data structure.

In Example 6, the subject matter of Example 5 optionally includes determining a direction for merging the first tree data structure and the second tree data structure, wherein the direction for merging into a merged tree data structure is based on weights that correspond to: whether a root of the merged tree data structure corresponds to the primary identifier; whether the root of the merged tree data structure has one or more tree leaves; and whether the root of the merged tree data structure is associated with an existing data record.

In Example 7, the subject matter of any one or more of Examples 1-6 optionally include wherein the merging of the multiple identifiers from the change events into the data structure occurs in real-time during use of the respective communication session segments.

In Example 8, the subject matter of any one or more of Examples 1-7 optionally include wherein the respective communication session segments involve at least one of: a user-to-user call, a multi-party call, a user-to-agent interaction, a meeting, a breakout room, a webinar, or a call transfer.

In Example 9, the subject matter of any one or more of Examples 1-8 optionally include wherein the data record associates information from a plurality of telemetry events associated with a user of the communications system during a call or meeting hosted by the communications system.

Example 10 is a non-transitory machine-readable medium, storing instructions for optimizing data protection for a data stream, the instructions, which when executed, cause a machine to perform operations comprising: receiving telemetry events from a communications system providing a communication session, wherein the communications system facilitates respective communication session segments between entities, and wherein the telemetry events include change events that are produced from changes to the respective communication session segments; extracting identifiers of related segments from the change events, wherein a respective event of the change events provides multiple identifiers including (i) a primary identifier of a first communication session segment and (ii) a secondary identifier of a second communication session segment related to the first communication session segment; merging the multiple identifiers from the change events into a data structure, when a respective primary identifier or a respective secondary identifier is already tracked in the data structure; and outputting a data record for the communication session, based on data relationships merged into the data structure, wherein the data record uses the multiple identifiers to create an association among the telemetry events produced by the related segments of the communication session.

In Example 11, the subject matter of Example 10 optionally includes wherein a respective event provides multiple pairs of primary identifiers and secondary identifiers, and wherein the operations further comprise extracting the multiple pairs of primary identifiers and secondary identifiers from the respective event.

In Example 12, the subject matter of any one or more of Examples 10-11 optionally include wherein the first communication session segment involves a call occurring via the communications system, wherein the primary identifier is an identifier of the call, and wherein the secondary identifier is another identifier of a related call or action occurring in the communications system to be associated with the call.

In Example 13, the subject matter of any one or more of Examples 10-12 optionally include wherein the data structure is maintained as a tree data structure in a database using a multi-row storage pattern, wherein a respective data entry stored in a row of the database indicates a key, a tree root, and a tree leaf of the tree data structure.

In Example 14, the subject matter of Example 13 optionally includes wherein the tree data structure is a first tree data structure, wherein the merging of the multiple identifiers includes merging data from a second tree data structure into the first tree data structure, by adding data from the second tree data structure as leaves of the first tree data structure.

In Example 15, the subject matter of Example 14 optionally includes determining a direction for merging the first tree data structure and the second tree data structure, wherein the direction for merging into a merged tree data structure is based on weights that correspond to: whether a root of the merged tree data structure corresponds to the primary identifier; whether the root of the merged tree data structure has one or more tree leaves; and whether the root of the merged tree data structure is associated with an existing data record.

In Example 16, the subject matter of any one or more of Examples 10-15 optionally include wherein the merging of the multiple identifiers from the change events into the data structure occurs in real-time during use of the respective communication session segments.

In Example 17, the subject matter of any one or more of Examples 10-16 optionally include wherein the respective communication session segments involve at least one of: a user-to-user call, a multi-party call, a user-to-agent interaction, a meeting, a breakout room, a webinar, or a call transfer.

In Example 18, the subject matter of any one or more of Examples 10-17 optionally include wherein the data record associates information from a plurality of telemetry events associated with a user of the communications system during a call or meeting hosted by the communications system.

Example 19 is a computing device adapted for tracking identifiers used in a communication session hosted by a communications system, the computing device comprising: a hardware processor; an interface to receive a data stream of telemetry events from a communications system, wherein the communications system facilitates respective communication session segments, wherein the telemetry events include change events that are produced from changes to the respective communication session segments; and a memory device, the memory device storing instructions, which when executed by the hardware processor, cause the computing device to perform operations that: extract identifiers of related segments from the change events, wherein a respective event of the change events provides multiple identifiers including (i) a primary identifier of a first communication session segment and (ii) a secondary identifier of a second communication session segment related to the first communication session segment; merge the multiple identifiers from the change events into a data structure, when a respective primary identifier or a respective secondary identifier is already tracked in the data structure; and output a data record for the communication session, based on data relationships merged into the data structure, wherein the data record uses the multiple identifiers to create an association among the telemetry events produced by the related segments of the communication session.

In Example 20, the subject matter of Example 19 optionally includes wherein a respective event provides multiple pairs of primary identifiers and secondary identifiers, and wherein the instructions further cause the computing device to perform operations that extract the multiple pairs of primary identifiers and secondary identifiers from the respective event.

In Example 21, the subject matter of any one or more of Examples 19-20 optionally include wherein the first communication session segment involves a call occurring via the communications system, wherein the primary identifier is an identifier of the call, and wherein the secondary identifier is another identifier of a related call or action occurring in the communications system to be associated with the call.

In Example 22, the subject matter of any one or more of Examples 19-21 optionally include wherein the data structure is maintained as a tree data structure in a database using a multi-row storage pattern, wherein a respective data entry stored in a row of the database indicates a key, a tree root, and a tree leaf of the tree data structure.

In Example 23, the subject matter of Example 22 optionally includes wherein the tree data structure is a first tree data structure, wherein the merging of the multiple identifiers includes merging data from a second tree data structure into the first tree data structure, by adding data from the second tree data structure as leaves of the first tree data structure.

In Example 24, the subject matter of Example 23 optionally includes wherein the instructions further cause the computing device to perform operations that: determine a direction for merging the first tree data structure and the second tree data structure, wherein the direction for merging into a merged tree data structure is based on weights that correspond to: whether a root of the merged tree data structure corresponds to the primary identifier; whether the root of the merged tree data structure has one or more tree leaves; and whether the root of the merged tree data structure is associated with an existing data record.

In Example 25, the subject matter of any one or more of Examples 19-24 optionally include wherein the merging of the multiple identifiers from the change events into the data structure occurs in real-time during use of the respective communication session segments.

In Example 26, the subject matter of any one or more of Examples 19-25 optionally include wherein the respective communication session segments involve at least one of: a user-to-user call, a multi-party call, a user-to-agent interaction, a meeting, a breakout room, a webinar, or a call transfer.

In Example 27, the subject matter of any one or more of Examples 19-26 optionally include wherein the data record associates information from a plurality of telemetry events associated with a user of the communications system during a call or meeting hosted by the communications system.

Example 28 is a computing apparatus adapted for tracking identifiers used in a communication session hosted by a communications system, comprising: means for obtaining telemetry events from the communications system, wherein the communications system facilitates respective communication session segments between entities, and wherein the telemetry events include change events that are produced from changes to the respective communication session segments; means for extracting identifiers of related segments from the change events, wherein a respective event of the change events provides multiple identifiers including (i) a primary identifier of a first communication session segment and (ii) a secondary identifier of a second communication session segment related to the first communication session segment; means for merging the multiple identifiers from the change events into a data structure, when a respective primary identifier or a respective secondary identifier is already tracked in the data structure; and means for outputting a data record for the communication session, based on data relationships merged into the data structure, wherein the data record uses the multiple identifiers to create an association among the telemetry events produced by the related segments of the communication session.

In Example 29, the subject matter of Example 28 optionally includes means for maintaining the data structure as a tree data structure using a multi-row pattern, wherein a respective data entry stored in a row indicates a key, a tree root, and a tree leaf of the tree data structure; wherein the tree data structure is a first tree data structure, wherein the merging of the multiple identifiers includes merging data from a second tree data structure into the first tree data structure, by adding data from the second tree data structure as leaves of the first tree data structure.

In Example 30, the subject matter of Example 29 optionally includes means for determining a direction for merging the first tree data structure and the second tree data structure, wherein the direction for merging into a merged tree data structure is based on: whether a root of the merged tree data structure corresponds to the primary identifier; whether the root of the merged tree data structure has one or more tree leaves; and whether the root of the merged tree data structure is associated with an existing data record.

Example 31 is at least one machine-readable medium (e.g., a non-transitory computer-readable storage medium) including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

1. A method for tracking identifiers used in a communication session hosted by a communications system, comprising:
receiving telemetry events from the communications system, wherein the communications system facilitates respective communication session segments between entities, and wherein the telemetry events include change events that are produced from changes to the respective communication session segments;
extracting identifiers of related segments from the change events, wherein a respective event of the change events provides multiple identifiers including (i) a primary identifier of a first communication session segment and (ii) a secondary identifier of a second communication session segment related to the first communication session segment;
merging the multiple identifiers from the change events into a merged tree data structure, wherein the merging occurs when a respective primary identifier or a respective secondary identifier is already tracked in the merged tree data structure, wherein the merging includes determining a direction for merging a first tree data structure and a second tree data structure into the merged tree data structure, and wherein the direction for merging is based on weights that correspond to characteristics associated with a root of the merged tree data structure; and
outputting a data record for the communication session, based on data relationships merged into the merged tree data structure, wherein the data record uses the multiple identifiers to create an association among the telemetry events produced by the related segments of the communication session.

2. The method of claim 1, wherein a respective event provides multiple pairs of primary identifiers and secondary identifiers, and wherein the method includes extracting the multiple pairs of primary identifiers and secondary identifiers from the respective event.

3. The method of claim 1, wherein the first communication session segment involves a call occurring via the communications system, wherein the primary identifier is an identifier of the call, and wherein the secondary identifier is another identifier of a related call or action occurring in the communications system to be associated with the call.

4. The method of claim 1, wherein the merged tree data structure is maintained as a tree data structure in a database using a multi-row storage pattern, wherein a respective data entry stored in a row of the database indicates a key, a tree root, and a tree leaf of the tree data structure.

5. The method of claim 4, wherein the merged tree data structure is a first tree data structure, wherein the merging of the multiple identifiers includes merging data from a second tree data structure into the first tree data structure, by adding data from the second tree data structure as leaves of the first tree data structure.

6. The method of claim 5, further comprising:
wherein the direction for merging into a merged tree data structure is based on weights that correspond to:
whether a root of the merged tree data structure corresponds to the primary identifier;
whether the root of the merged tree data structure has one or more tree leaves; and
whether the root of the merged tree data structure is associated with an existing data record.

7. The method of claim 1, wherein the merging of the multiple identifiers from the change events into the merged tree data structure occurs in real-time during use of the respective communication session segments.

8. The method of claim 1, wherein the respective communication session segments involve at least one of: a user-to-user call, a multi-party call, a user-to-agent interaction, a meeting, a breakout room, a webinar, or a call transfer.

9. The method of claim 1, wherein the data record associates information from a plurality of telemetry events associated with a user of the communications system during a call or meeting hosted by the communications system.

10. A non-transitory machine-readable medium, storing instructions for tracking identifiers used in a communication session, the instructions, which when executed, cause a machine to perform operations comprising:
receiving telemetry events from a communications system providing a communication session, wherein the communications system facilitates respective communication session segments between entities, and wherein the telemetry events include change events that are produced from changes to the respective communication session segments;
extracting identifiers of related segments from the change events, wherein a respective event of the change events provides multiple identifiers including (i) a primary identifier of a first communication session segment and (ii) a secondary identifier of a second communication session segment related to the first communication session segment;
merging the multiple identifiers from the change events into a merged tree data structure, wherein the merging occurs when a respective primary identifier or a respective secondary identifier is already tracked in the merged tree data structure, and wherein the merging includes determining a direction for merging a first tree data structure and a second tree data structure into the merged tree data structure, wherein the direction for merging is based on weights that correspond to characteristics associated with a root of the merged tree data structure; and
outputting a data record for the communication session, based on data relationships merged into the merged tree data structure, wherein the data record uses the multiple identifiers to create an association among the telemetry events produced by the related segments of the communication session.

11. The non-transitory machine-readable medium of claim 10, wherein a respective event provides multiple pairs of primary identifiers and secondary identifiers, and wherein the operations further comprise extracting the multiple pairs of primary identifiers and secondary identifiers from the respective event.

12. The non-transitory machine-readable medium of claim 10, wherein the first communication session segment involves a call occurring via the communications system, wherein the primary identifier is an identifier of the call, and wherein the secondary identifier is another identifier of a related call or action occurring in the communications system to be associated with the call.

13. The non-transitory machine-readable medium of claim 10, wherein the merged tree data structure is maintained as a tree data structure in a database using a multi-row storage pattern,
wherein a respective data entry stored in a row of the database indicates a key, a tree root, and a tree leaf of the tree data structure,
wherein the merged tree data structure is a first tree data structure, and wherein the merging of the multiple identifiers includes merging data from a second tree data structure into the first tree data structure, by adding data from the second tree data structure as leaves of the first tree data structure.

14. The non-transitory machine-readable medium of claim 13, further comprising:
wherein the direction for merging into a merged tree data structure is based on weights that correspond to:
whether a root of the merged tree data structure corresponds to the primary identifier;
whether the root of the merged tree data structure has one or more tree leaves; and
whether the root of the merged tree data structure is associated with an existing data record.

15. The non-transitory machine-readable medium of claim 10, wherein the data record associates information from a plurality of telemetry events associated with a user of the communications system during a call or meeting hosted by the communications system.

16. A computing device adapted for tracking identifiers used in a communication session hosted by a communications system, the computing device comprising:
a hardware processor;
an interface to receive a data stream of telemetry events from a communications system, wherein the communications system facilitates respective communication session segments, wherein the telemetry events include change events that are produced from changes to the respective communication session segments; and
a memory device, the memory device storing instructions, which when executed by the hardware processor, cause the computing device to perform operations that:
extract identifiers of related segments from the change events, wherein a respective event of the change events provides multiple identifiers including (i) a primary identifier of a first communication session segment and (ii) a secondary identifier of a second communication session segment related to the first communication session segment;
merge the multiple identifiers from the change events into a merged tree data structure, wherein the merging occurs when a respective primary identifier or a respective secondary identifier is already tracked in the merged tree data structure, wherein the merging includes determining a direction for merging a first tree data structure and a second tree data structure into the merged tree data structure, and wherein the direction for merging is based on weights that correspond to characteristics associated with a root of the merged tree data structure; and
output a data record for the communication session, based on data relationships merged into the merged tree data structure, wherein the data record uses the multiple identifiers to create an association among the telemetry events produced by the related segments of the communication session.

17. The computing device of claim 16, wherein a respective event provides multiple pairs of primary identifiers and secondary identifiers, and wherein the instructions further cause the computing device to perform operations that extract the multiple pairs of primary identifiers and secondary identifiers from the respective event.

18. The computing device of claim 16, wherein the first communication session segment involves a call occurring via the communications system, wherein the primary identifier is an identifier of the call, and wherein the secondary identifier is another identifier of a related call or action occurring in the communications system to be associated with the call.

19. The computing device of claim 16, wherein the merged tree data structure is maintained as a tree data structure in a database using a multi-row storage pattern,
wherein a respective data entry stored in a row of the database indicates a key, a tree root, and a tree leaf of the tree data structure,
wherein the merged tree data structure is a first tree data structure, and
wherein the merging of the multiple identifiers includes merging data from a second tree data structure into the first tree data structure, by adding data from the second tree data structure as leaves of the first tree data structure.

20. The computing device of claim 19, wherein the instructions further cause the computing device to perform operations that:
wherein the direction for merging into a merged tree data structure is based on weights that correspond to:
whether a root of the merged tree data structure corresponds to the primary identifier;
whether the root of the merged tree data structure has one or more tree leaves; and
whether the root of the merged tree data structure is associated with an existing data record.
